(19) United States
(12) Patent Application Publication
(10) Pub. No.: US 2006/0108757 A1
(43) Pub. Date: May 25, 2006

(54) Catering cart having gravity-feed and counter system

(76) Inventors: Derek A. Brookmire, Redondo Beach, CA (US); Gopalkrishan M. Vashist, Redondo Beach, CA (US)

Correspondence Address: CONNOLLY BOVE LODGE & HUTZ LLP, SUITE 800, 1990 M STREET NW, WASHINGTON, DC, 20036-3425, US

(21) Appl. No.: 11/234,243

(22) Filed: Sep. 26, 2005

Related U.S. Application Data
(60) Provisional application No. 60/612,506, filed on Sep. 24, 2004.
(60) Provisional application No. 60/692,233, filed on Jun. 21, 2005.

(51) Int. Cl. B62B 3/00

(52) U.S. Cl. 280/47.34

(57) ABSTRACT

According to one embodiment, a cart for serving catering items includes trays inclined at an angle. The inclined trays facilitate gravity feeding of the catering items from the trays. The trays can be divided into slots, each slot including a stock of items that can be fed from the slots. According to another embodiment, a catering cart includes a removable gravity feed insert which includes tray assemblies inclined at an angle to promote gravity feeding of the catering items from the tray assemblies. The tray assemblies may include front trays and rear trays that can be fastened together, or separated to allow the use of a front tray or rear tray alone. The trays, once removed from the cart, can be neatly stacked on top of each other for transport and/or storage.

This application claims the benefit of U.S. provisional application No. 60/612,506, filed Sep. 24, 2004 and U.S. provisional application No. 60/692,233, filed Jun. 21, 2005.

### BACKGROUND

1. Technical Field

The invention relates trolleys or carts used to store and transport items.

2. Related Art

Trolleys or carts can be used for a variety of purposes. For example, catering carts can be used to store and transport snacks, dishes, supplies, and beverages. Carts are often used by airlines to serve passengers during flights. Each flight is serviced separately, and carts are loaded and unloaded at each stop, so it is important to minimize handling and ground time. Existing carts have several drawbacks, however. For example, conventional catering carts have drawers that are used to store catering supplies, and the arrangement of items in the drawers often leads to confusion and inefficiency in service. It is difficult to identify items that are either present in or have been withdrawn from drawers, making tracking of stock rotation cumbersome. Further, the drawers may crack due to misuse and mishandling, and are also heavy when full and they must be washed periodically.

### SUMMARY

According to a first embodiment, a catering cart comprises a frame and at least one row inclined at a nonzero angle, wherein the angle of inclination promotes gravity feeding of catering items, such as cans, bottles or snack packages from the row. The row may be divided into a plurality of slots, and a counter may be provided on at least one of the slots, the counter being disposed to account for an item removed from the slot.

According to a second embodiment, a catering cart comprises a gravity-feed insert assembly that may easily be inserted and removed from the cart. The gravity-feed insert assembly includes at least one tray inclined at a nonzero angle for dispensing catering items from the cart by gravity feed.

The disclosed devices provide efficient, cost-effective solutions for storing and dispensing catering items from a catering cart. Other features and advantages will become apparent from the following detailed description and drawings.

### BRIEF DESCRIPTION OF THE DRAWINGS

FIG. 1 is a front elevational view of a catering cart according to a first embodiment, with a front door of the cart opened;

FIG. 2 is a front elevational view of a catering cart according to the first embodiment, with a front door of the cart closed;

FIG. 3 is a rear elevational view of the first embodiment, with a rear door of the cart opened;

FIG. 4 is a rear elevational view of the first embodiment, with a rear door of the cart closed;

FIG. 5 is a partially exploded side elevational view of the first embodiment, with a side of the cart opened to show rows in the interior of the cart;

FIG. 6 is a side elevational view of the first embodiment; and

FIG. 7 is a top plan view of the first embodiment.

FIG. 8 is an isometric view of a catering cart according to second embodiment including a gravity-feed insert assembly.

FIG. 9 a front view of the catering cart of FIG. 8.

FIG. 10 is a rear view of the catering cart of FIG. 8.

FIG. 11 is a front view of a gravity-feed insert assembly for the cart of FIGS. 8-10.

FIG. 12 is a front elevation view of tray assemblies of the gravity-feed insert assembly of FIG. 11.

FIG. 13 is a side view of a gravity-feed insert assembly.

FIG. 14 is a rear view of a gravity-feed insert assembly.

FIG. 15 is a rear view of a tray for a gravity-feed insert assembly.

FIG. 16 is an exploded isometric view of a gravity-feed insert assembly.

FIG. 17 is a partial isometric view of a gravity-feed insert assembly, showing beverage counter mechanisms.

FIG. 18 is an isometric view of front and rear trays of a gravity-feed insert assembly.

FIG. 19 is a top view of a front and rear tray of a tray assembly.

FIGS. 20A and 20B are partial bottom views of front and rear trays of a tray assembly.

### DETAILED DESCRIPTION

Embodiments of the invention are addressed to a catering cart having a gravity feed system for dispensing catering supplies such as food, beverages and other items.

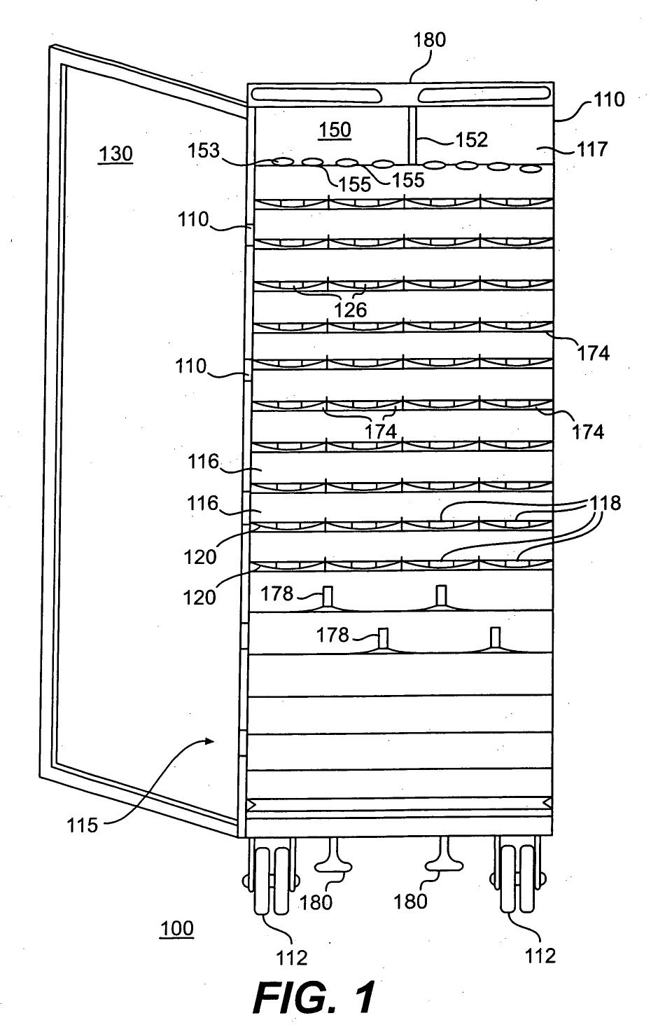

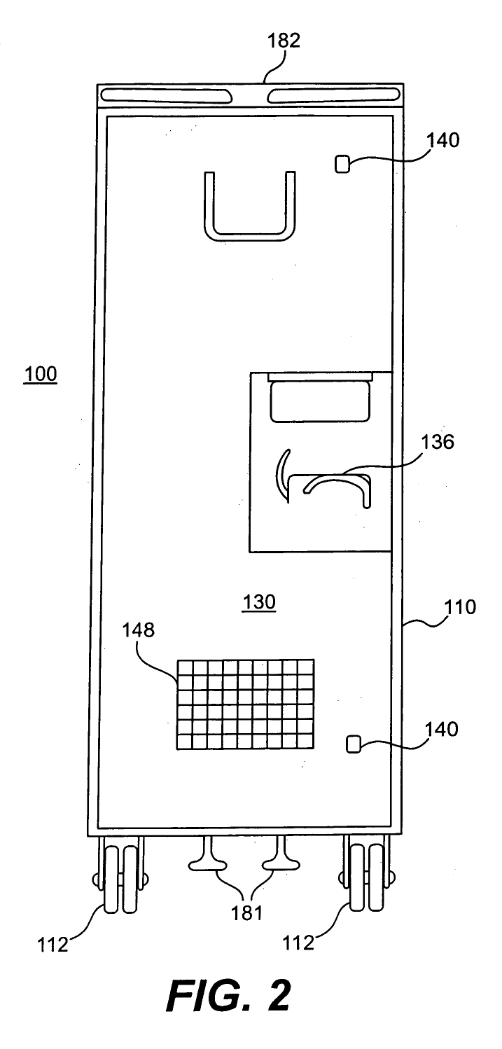

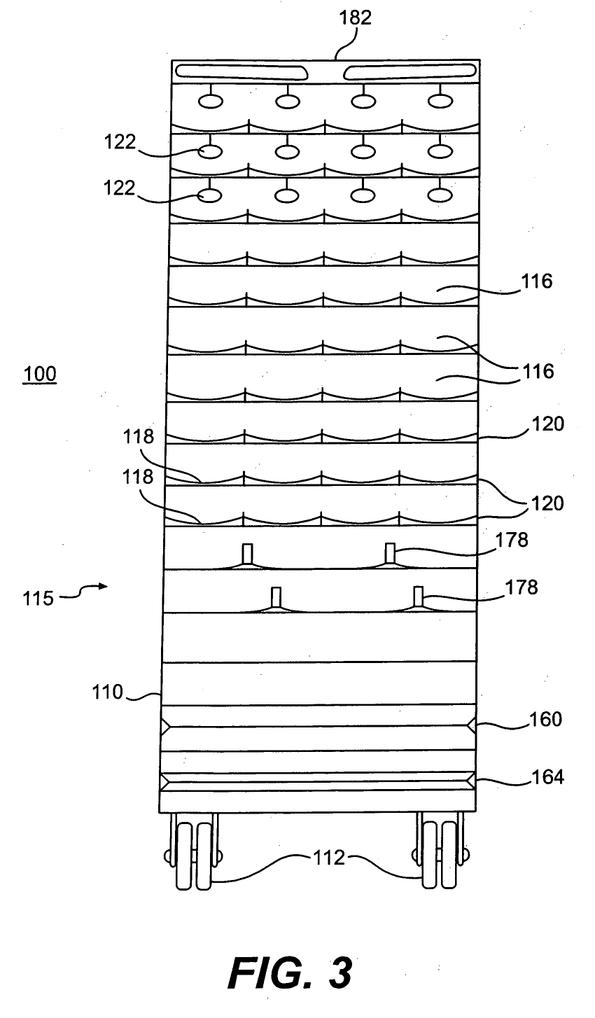

FIG. 1 is a front elevational view of a catering cart 100 according to a first embodiment. FIG. 2 is a rear elevational view of the embodiment shown in FIG. 1. FIG. 3 is a side elevational view of the embodiment shown in FIG. 1. The cart 100 can be a full trolley or half trolley.

Referring to FIGS. 1-3, the catering cart 100 comprises a frame 110 mounted on wheels 112. The cart 100 includes a gravity feed guide system 115. Referring to FIG. 3, the guide system 115 is segregated into a plurality of trays 116. Referring to FIGS. 1 and 3, each tray 116 is divided into a plurality of slots 118. Each slot 118 includes a lip 120 at a front or lower end of the slot 118 for retaining items until the item is pulled for use. Each slot 118 can also include identifying indicia 122 (FIG. 3) at the front and back of the slot 118 so that a user can identify the type of item held in the slot 118. Further, items within the slots 118 are visible from the front and rear of the cart 100. Each slot 118 can also include a counter 126 that tracks items dispensed from that slot 118. The counter 126 may, for example, be a dipstick slidably mounted in the tray 116 and including numerical markings (not shown) along its length indicating the number of items remaining in or removed from the slot 118. The rear end of the dipstick may include a projection (not shown) engaging the rearmost item in the slot and prohibiting further movement of the dipstick towards the front of the slot 118. Thus, the dipstick can be pulled outward from the tray 116 until its projection engages an item in the slot 118, and the number of items removed from or remaining in the slot 118 can be determined by the alignment of a numerical marking with a fixed reference point on the tray 116 or slot 118. Handles 180, 182 can be included at the front and rear of the cart 100, respectively.

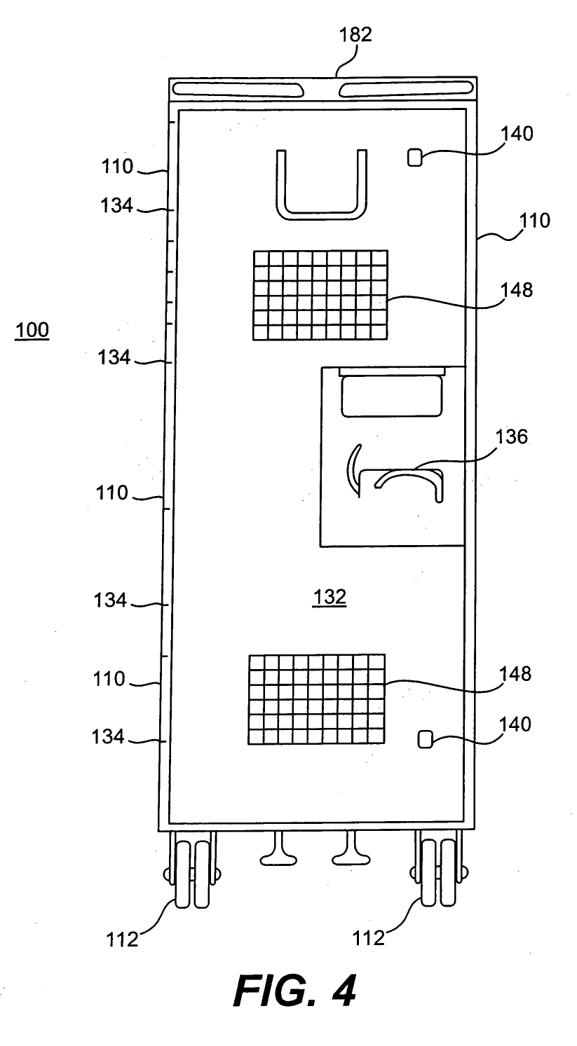

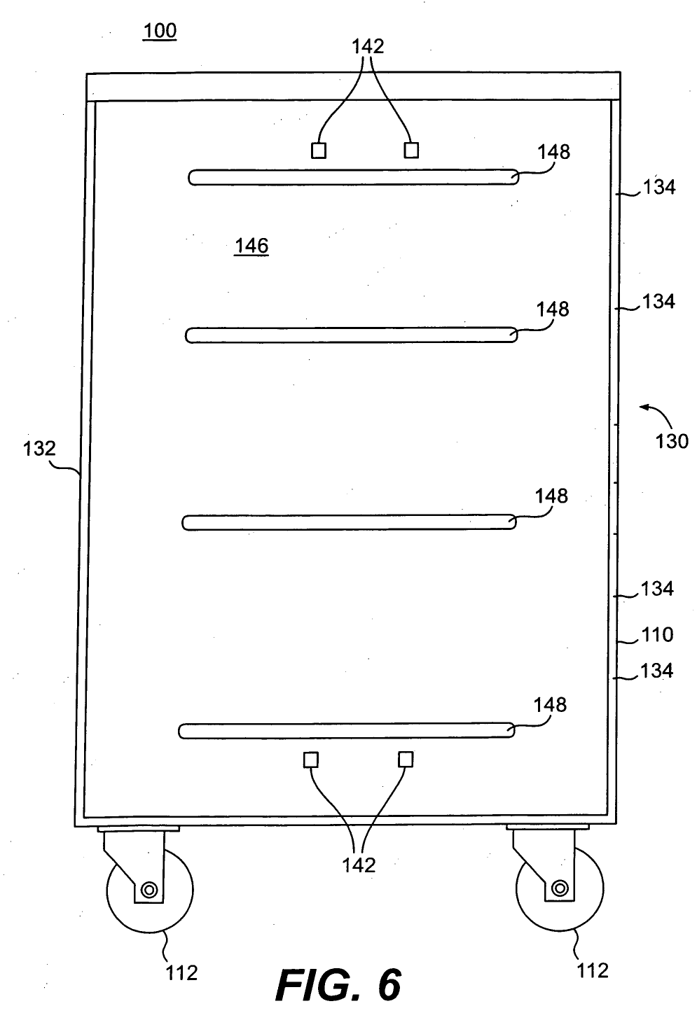

The cart 100 includes a front door 130 (FIG. 2) at the front of the frame 110 and a back door 132 (FIG. 4) at the rear of the frame 110. The doors 130, 132 are attached to the frame 110 by hinges 134, and locks 136 can be provided at each door 130, 132. Each door 130, 132 may also include magnets 140 on the outside of the door. A side 146 (FIG. 6) of the cart can include magnets 142 that are aligned with magnets 140 when the doors 130, 132 are open so that when the cart 100 is in use, the doors 130, 132 are held against the side 146 of the cart 100. Brakes 181 can be included to prevent motion of the cart 100. Brakes 181 may be of a known type including pedals for engaging and disengaging the brakes.

FIG. 6 is a side elevational view of the first embodiment. Referring to FIG. 6, the sides 146 of the cart 100 may have horizontal vents 148 or a grill inlay (not shown) that promotes air flow through the cart 100.

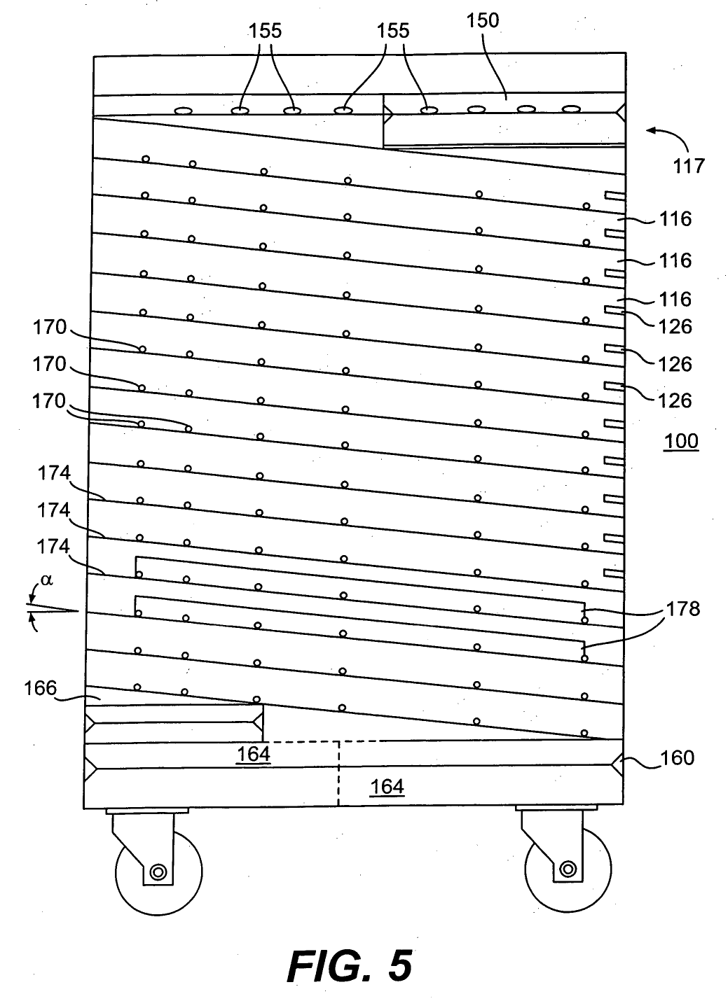

Referring to FIGS. 1 and 5, a top tray 117 may be a half row with top replenishment access. The top tray 117 may be divided into two separate compartments 150 separated by a wall 152. The floor 153 of each compartment may include a grill 155 to facilitate air flow through the compartments 150. Items such as liquors, miniature bottles, dry ice and napkins, among other items, can be stored in the compartments 150.

Referring to FIG. 5, a bottom compartment 160 can be located below the trays 116. The bottom compartment 160 can include two sliding drawers 164 and one half drawer 166. Items such as wet ice, wines, silverware, coffee and tea bags, among other items, can be stored in the drawers 164, 166.

The trays 116, and the slots 118 of the trays 116, are inclined at an angle α, which facilitates removal of items from the slots 118. The angle α may be at least about 3 degrees to facilitate the movement of items in the slots 118. Larger angles, such as angles exceeding 5 or 10 degrees, may also be used.

One or more of the slots 118 may also include slide enhancing devices 170, such as ball bearings or rollers, which facilitate gravity feeding of items from the slots 118. Each tray 116 may be defined by a bottom wall 174. Adjustable walls 178 may be mounted on the bottom walls 174. The adjustable walls 178 can be selectively placed across the width of the rows 116 to create slots 118 of differing width.

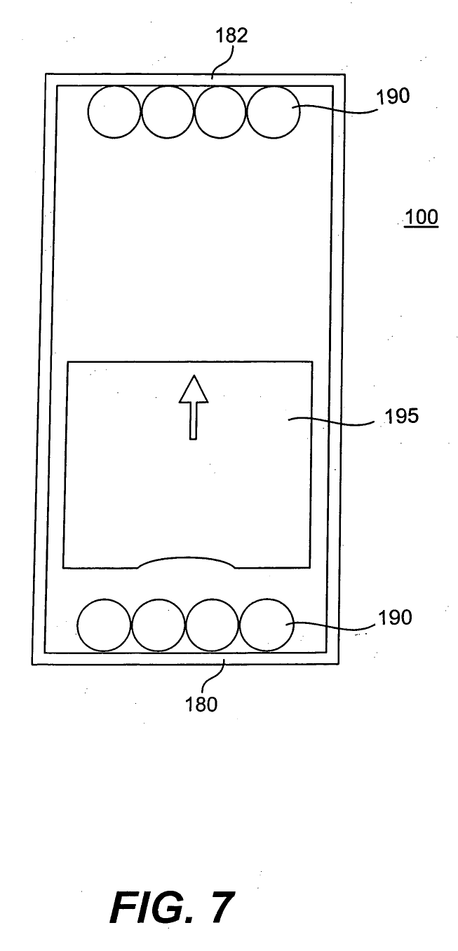

FIG. 7 is a top plan view of the cart 100. The top of the cart 100 can include a sliding panel 195 that allows access to the top row 117. Cupholders 190 may also be provided at the front and rear of the cart 100 to hold beverage containers while the cart is in use. For example, flight attendants may store half-empty beverage cans in the cupholders 190 while serving passengers.

The above embodiments organize and segregate items stored in the cart 100. The cart 100 allows for tracking of items stored and dispensed from the cart 100, and other aspects of usage. Items are easily distributed from and replenished in the cart 100. In contrast with carts having primarily drawer storage, air flow is promoted, and items are easily identified in the cart 100.

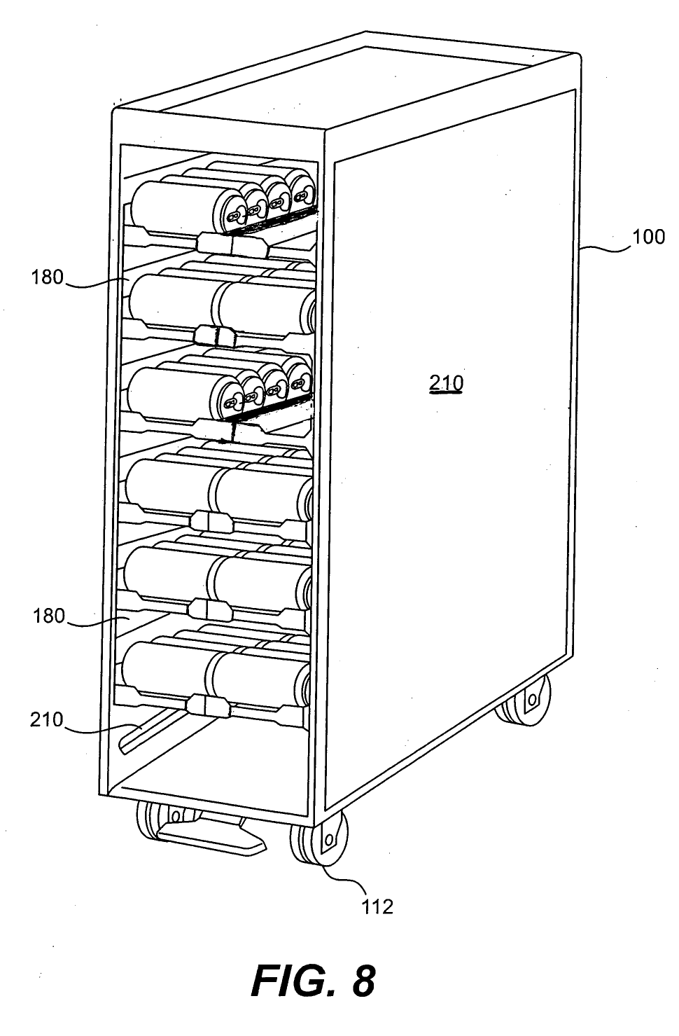

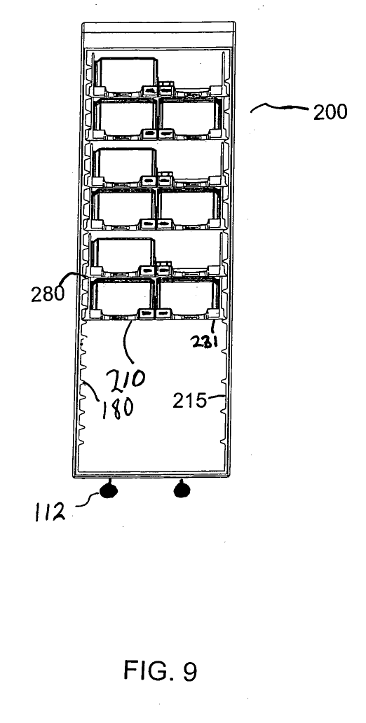

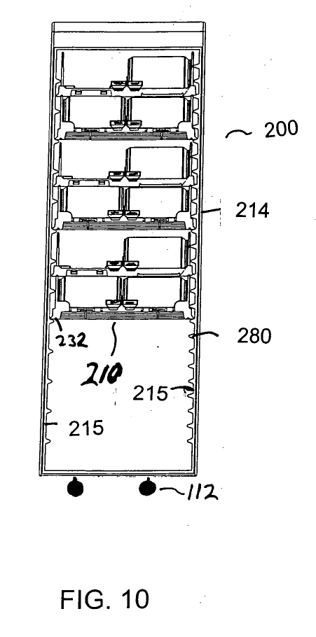

FIG. 8 is an isometric view of a catering cart 200 according to another embodiment. FIGS. 9 and 10 are front and rear views, respectively, of the embodiment shown in FIG. 8.

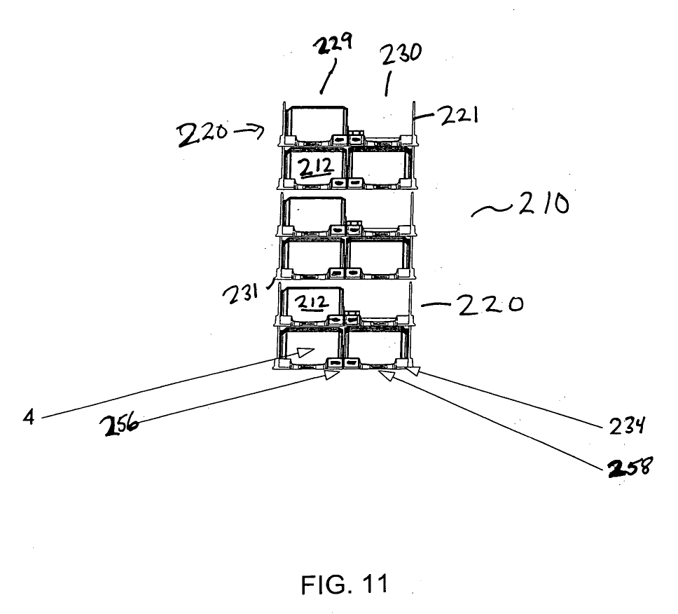

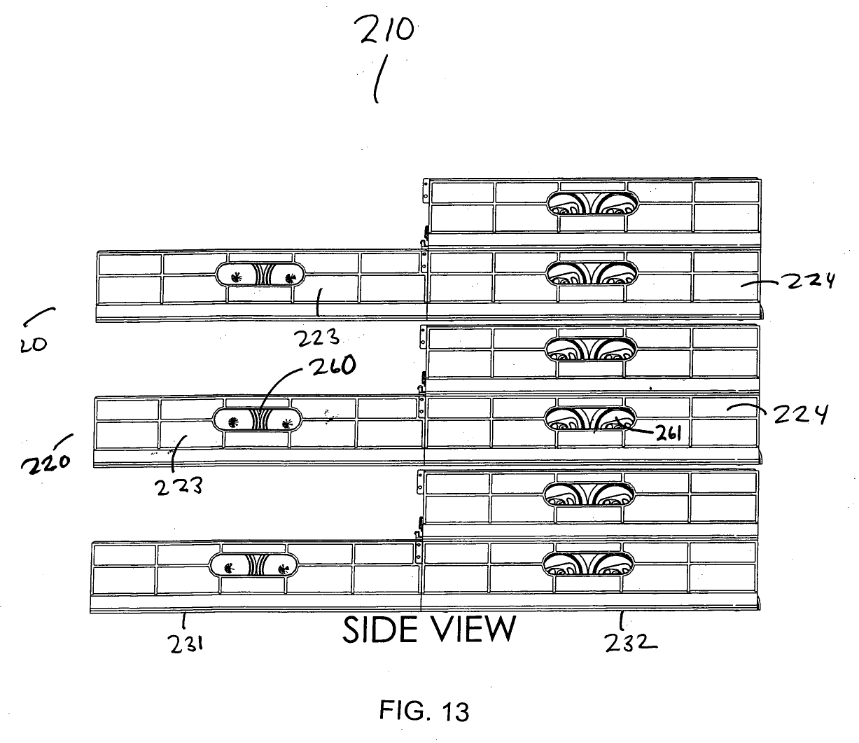

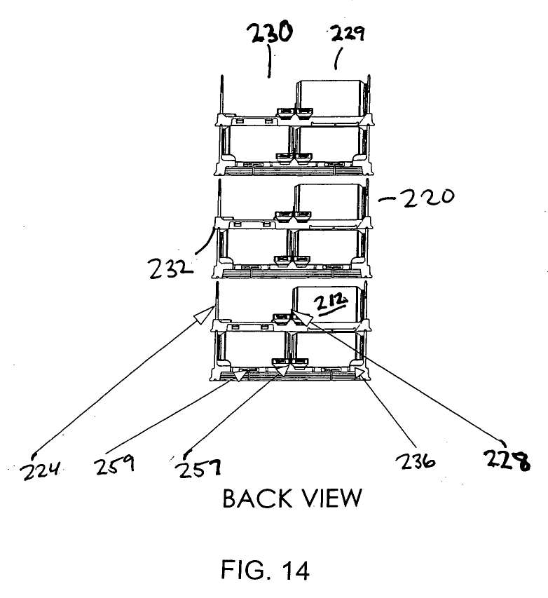

Referring to FIGS. 8-10, the catering cart 200 comprises a frame 214 mounted on wheels 112. The cart 200 includes a gravity-feed insert assembly 210 for storing and dispensing catering supplies such as beverage cans 212. With reference to FIGS. 11-14, the insert assembly 210 comprises one or more tray assemblies 220 mounted on inside the frame 214 of the catering cart 200. The tray assemblies 220 may be made from plastic or another suitable material, with high strength and light weight being important considerations. Each tray assembly 220 includes a front tray 221 and may include a rear tray 222 connected to the front tray 221. The rear trays 222 are connected to the front trays 221 by interlocking joints 240, as shown in FIG. 13A. The trays 221, 222 may each include a pair of longitudinal side walls 223, 224, a bottom surface 225, 226 and a longitudinal separation wall 227, 228 that divides the tray 221, 222 into two slots 229, 230. The trays 221, 222 in the embodiment of FIGS. 8-14 are arranged such that each slot 229, 230 can store and dispense beverage cans 212 arranged in a horizontal position. Naturally, additional separation walls 227, 228 may be employed, and the width of the trays 220 may be altered as necessary to provide any number of slots 229. 230. Additionally, the trays 221, 222 may be configured and sized such that beverage cans 212 can be stored and dispensed in a vertical position. Furthermore, the trays 221, 222 may be configured and sized to accommodate other types of catering items, such as food packages.

The cart 200 shown in FIGS. 8-10 is representative of a full-sized airline catering cart. In such an embodiment, the front trays 221 and rear trays 222 may be approximately fifteen inches long each, so as to form a thirty-inch-long pathway for catering items. Where an airline “half cart” (not shown) is used, only the front trays 221 will be used, as the half cart is too small to accommodate both the front trays 221 and rear trays 222. To facilitate use of the front trays 221 in airline half carts, the rear trays 222 may be separated from the front trays 221 by unlocking the interlocking joints 240.

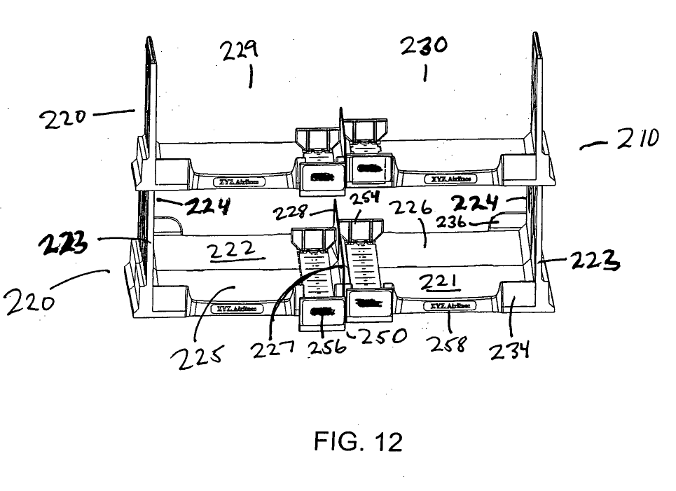

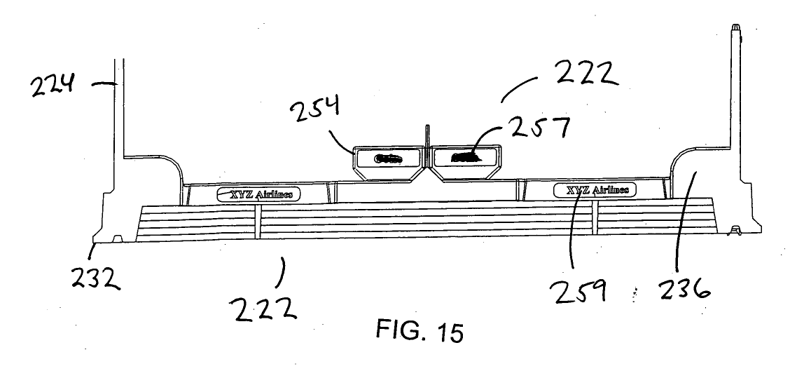

Referring back to FIGS. 8-10, a plurality of vertically-spaced longitudinal tracks 280 are located on the inside surface of each side wall 215 of the frame 214. The longitudinal tracks 280 are inclined at a nonzero angle to allow the tray assemblies 220 to be mounted to the frame 110 at an inclined angle (i.e., such that the bottom surfaces of the trays are positioned at a nonzero angle). The angle of incline for the tray assemblies 220 may be 3 degrees or greater. More specifically, the bottom edges 231, 232 of the front trays and rear trays 221, 222 rest on the tracks 280 such that the trays 221, 222 are supported in an inclined position. The inclined positioning allows the beverage cans 212 to be fed along the trays 221, 222 towards the front of the cart 100 under the force of gravity alone. To retain the frontmost beverage cans 212 in the front trays 221 and thereby prevent the beverage cans 212 from spilling out of the front trays 221 under the force of gravity, each front trays 221 includes a front retaining wall 234, as shown in FIG. 5. Referring to FIGS. 12 and 15, the rear trays 222 each include a rear retaining wall 236 for securing the rearmost beverage can 212 in the rear tray 222.

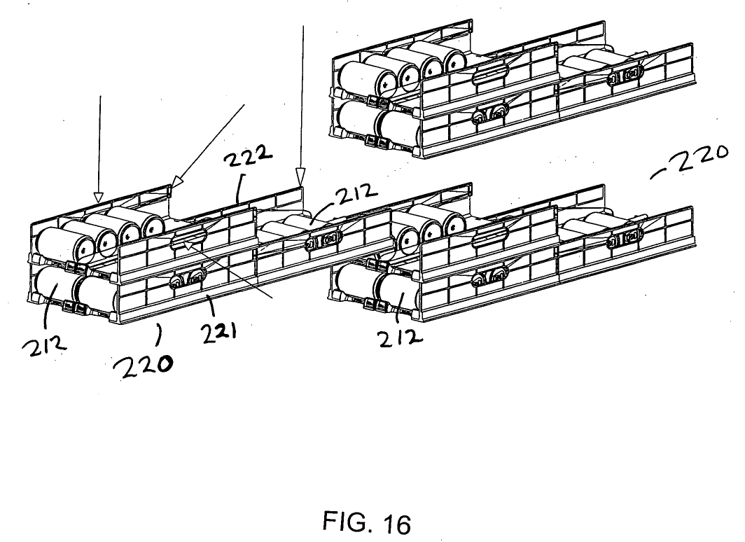

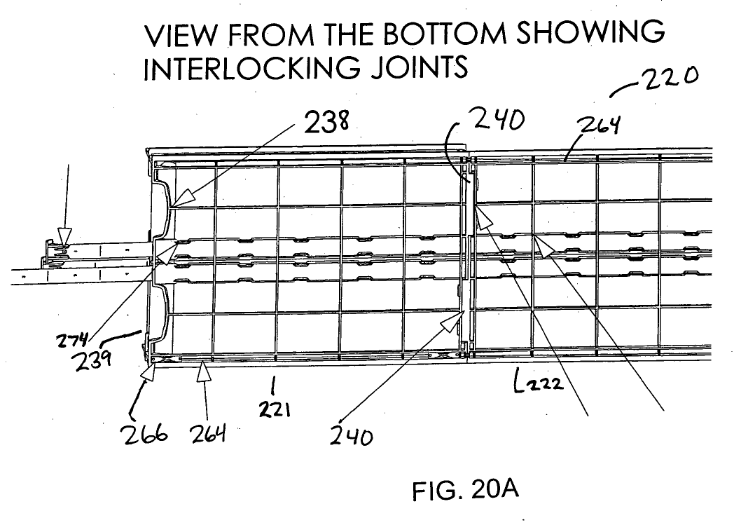

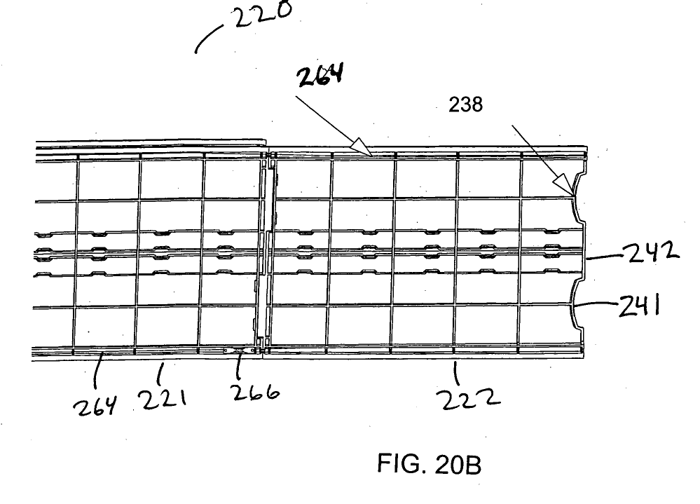

The operation of the gravity-feed insert assembly 210 will now be described. As can best be seen in FIGS. 8, 13 and 16, beverage cans 212 are loaded into the trays 221, 222 from the back side of the cart 200 until the trays 221 and 222 are filled as desired. When a user removes a frontmost can 212 from the from the front tray 221, the remaining cans in the trays 212, 222 roll or slide down the trays 221, 222 under the force of gravity until a frontmost remaining can 212 comes to rest against the front retaining wall 234. Thus, each time a can 212 is removed from the cart, remaining cans 212 in the trays 221, 222 advance towards the front of the cart 100. As shown in FIGS. 20A and 20B, the front trays 221 may include curved recesses 238 at their front sides 239 to facilitate removal of cans 212 from the front of the trays 221. Similarly, the rear trays 222 may include curved recesses 241 at their rear faces 242 to facilitate loading of the cans 212 into the trays 222.

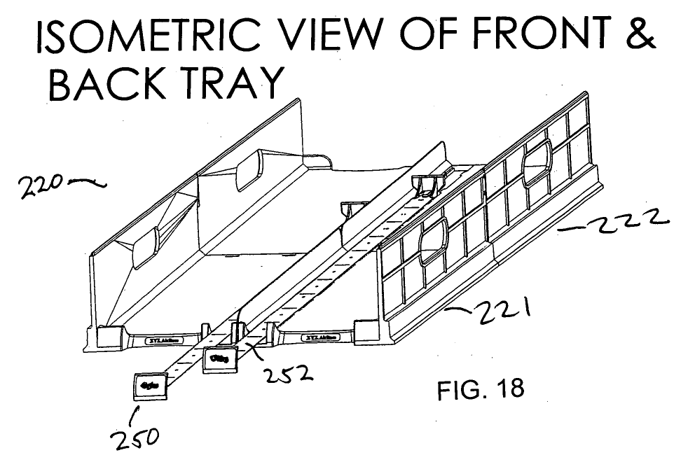

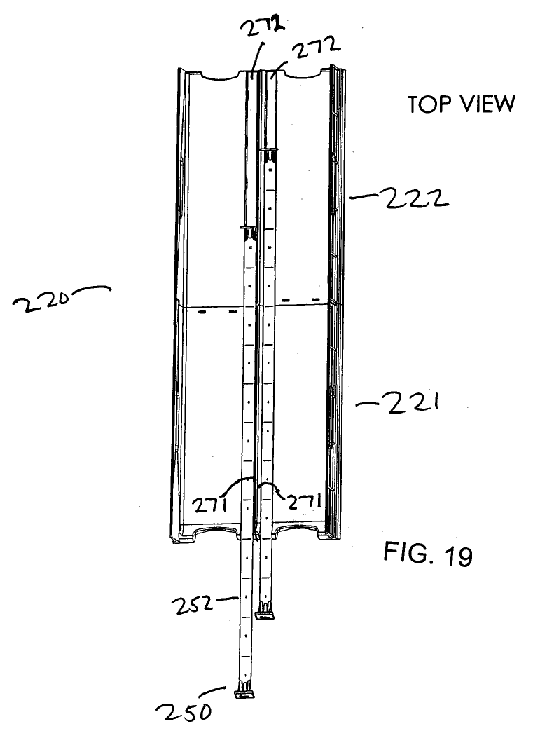

As best shown in FIGS. 12 and 17-20B, the tray assemblies 220 further include counter devices 250 arranged to track the number of cans 212 removed from or remaining in each slot 229, 230 of the cart 100. The counter devices 250 are dipsticks including numerical markings 252 along their length. The dipsticks 250 are slidably positioned in longitudinal channels 271, 272 in the trays 221, 222. Curved insertions 274 are provided to hold the dipsticks 250 in place. The numerical markings 252 correspond to the number of cans 212 removed from a row 229, 230. The dipsticks 250 may be provided in two different lengths to accommodate carts using the front trays 221 only or front trays 221 and rear trays 222. The dipsticks 250 include stop members 254 at rear ends thereof which are designed to engage the rearmost cans 212 in the trays 221 or 222. Further, as shown in FIGS. 11, 2 and 14, dipstick labels 256, 257 may be provided on the front and rear ends of the dipsticks 250 to indicate the product contained in the associated trays 221, 222. Additional labels 258, 259 may be provided on the front and back trays 221, 222 to identify the products or the company that owns or operates the cart.

At anytime during or after the use of the cart 200, a user may pull a dipstick 250 out towards the front of the cart until the stop member 254 engages the rearmost can 212 in a slot 229, 230 and stops movement of the dipstick 250. The user may then read the numerical marking 252 aligned with the front side 239 of the tray in order to determine the number of cans removed from or remaining in the tray. Thus, the counter devices 250 allow for easy determination of how many cans 212 have been used, and the contents of the cart 200 do not have to be emptied or examined to determine how many cans 212 have been used.

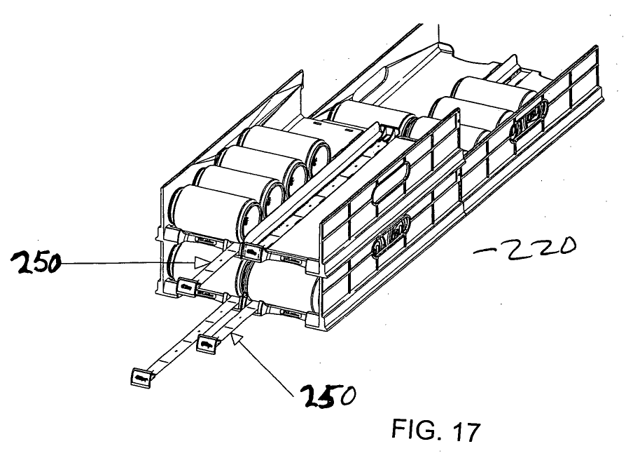

The tray assemblies 220 can be easily inserted into or removed from the cart 200 by sliding action along the tracks 180. To facilitate handling of the trays 221, 222 during installation into and removal from the cart 200, the trays 221, 222 may include openings 260, 261 for gripping the trays 221, 222 (see FIGS. 13 and 17). Additionally, the trays 221, 222 may be stacked on top of each other when stored outside the cart 100. To facilitate vertical stacking for storage, the trays 221, 222 may include underside grooves 264 for receiving the top of side walls 223, 224 of a lower tray 221, 222. Thus, an upper tray 221, 222 may easily slide onto the top a lower tray 221, 222. To further facilitate sliding of one tray on top of another, recessed wheels 266 may be included in the underside grooves 264.

As illustrated by the above description, the disclosed gravity-feed insert assembly provides an efficient, cost-effective solution for storing and dispensing catering items from a catering cart. Items are delivered to the front of the catering cart via gravitational force, thereby eliminating the need for complicated moving parts. Furthermore, the disclosed counter devices provide a simple, effective way to track items removed from the cart. The insert assembly is particularly useful for airline catering, as catering items may be neatly arranged within the cart and easily tracked. The counter devices allow a user to quickly determine the number and type of items needed to replenish the cart, and catering items can be replenished without requiring the cart to be removed from the airplane for inspection and refilling.

The foregoing description of the invention illustrates and describes the present invention. Additionally, the disclosure describes only selected preferred embodiments of the invention, but it is to be understood that the invention is capable of use in various other combinations, modifications, and environments and is capable of changes or modifications within the scope of the inventive concept as expressed herein, commensurate with the above teachings, and/or within the skill or knowledge of the relevant art.

The description is not intended to limit the invention to the form disclosed herein. Also, it is intended that the appended claims be construed to include alternative embodiments, not explicitly defined in the detailed description.

What is claimed is:

1. A cart for storing and dispensing catering items, comprising:
a frame; and
at least one tray mounted within the frame at an inclined, nonzero angle of inclination, wherein the angle of inclination promotes gravity feeding of items from the tray.

2. The cart of claim 1, wherein the at least one tray comprises a plurality of trays.

3. The cart of claim 2, wherein at least one of the trays is divided into a plurality of slots.

4. The cart of claim 1, wherein the at least one tray comprises at least five trays, each tray being inclined at the nonzero angle of inclination.

5. The cart of claim 1, wherein the nonzero angle of inclination is at least 3 degrees.

9. The cart of claim 1, comprising:
slide enhancing devices in the at least one tray that are arranged to facilitate sliding of catering items down the at least one tray.

11. A cart, comprising:
a frame;
at least one tray mounted within the frame and divided into a plurality of slots; and
a counter disposed near at least one slot among the plurality of slots, the counter being disposed to account for an item removed from or remaining in the at least one slot.

12. The cart of claim 11, wherein the at least one tray comprises a plurality of trays.

13. The cart of claim 12, wherein counter is disposed at an exit of a slot.

14. The cart of clam 11, wherein the counter comprises a dipstick that is slidably mounted in the at least one tray and includes numerical markers arranged to indicate a number of items removed from or remaining in the at least one slot.

15. The cart of claim 11, wherein the at least one tray comprises at least five trays, each tray being inclined at a nonzero angle.

16. The cart of claim 15, wherein the nonzero angle is at least 3 degrees.

17. A cart for storing and dispensing catering items, comprising:
a frame; and
a gravity feed insert assembly mounted within the frame and comprising at least one tray assembly, wherein the at least one tray assembly comprises at least one tray positioned at an inclined, nonzero angle of inclination, wherein the angle of inclination promotes gravity feeding of items from the tray.

18. The cart of claim 17, wherein the at least one tray assembly comprises front and rear trays adapted to fasten to one another.

19. The cart of claim 18, wherein the front and rear trays are adapted to fasten to one another and are adapted to be separated such that the front and rear trays may be individually installed in or removed from the cart.

20. The cart of claim 17, wherein the at least one tray assembly is supported on inclined tracks inside the frame.

21. The cart of claim 17, wherein the nonzero angle of inclination is at least 3 degrees.

22. The cart of claim 17, wherein the at least one tray is arranged to be removed from and installed in the cart without tools or additional fastening elements.

23. The cart of claim 17, wherein the at least one tray assembly comprises a plurality of tray assemblies, and wherein the tray assemblies are stackable one on top of another when removed from the cart.

24. The cart of claim 17, wherein the at least one tray assembly is divided into a plurality of slots and wherein at least one slot among the plurality of slots comprises a counter device that is slidably positioned within the at least one tray assembly and arranged to account for a number of items remaining in or removed from the at least one slot.

25. The cart of claim 17, wherein the counter mechanism comprises a dipstick that is slidably mounted in the at least one tray and includes numerical markers arranged to indicate a number of items removed from or remaining in the at least one slot.
